(19) United States
(12) Patent Application Publication
(10) Pub. No.: US 2020/0251900 A1
(43) Pub. Date: Aug. 6, 2020

(54) METHOD, MASTER STATION AND SYSTEM FOR PROCESSING PARAMETERS OF GRID-LOAD TERMINAL

(71) Applicants: STATE GRID JIANGSU ELECTRIC POWER CO., LTD, Jiangsu (CN); JIANGSU FRONTIER POWER TECHNOLOGY CO., LTD, Jiangsu (CN)

(72) Inventors: Yong XIA, Jiangsu (CN); Yaohong LI, Jiangsu (CN); Zhenyu CHEN, Jiangsu (CN); Xuefeng ZHAI, Jiangsu (CN); Jie FAN, Jiangsu (CN); Kaiming LUO, Jiangsu (CN); Chengliang WANG, Jiangsu (CN); Cheng LI, Jiangsu (CN); Hongxing WANG, Jiangsu (CN); Yujun LU, Jiangsu (CN); Hao CHEN, Jiangsu (CN); Jiajia CAO, Jiangsu (CN); Ning WANG, Jiangsu (CN); Yonggao GE, Jiangsu (CN)

(21) Appl. No.: 16/398,730

(22) Filed: Apr. 30, 2019

(30) Foreign Application Priority Data
Feb. 1, 2019 (CN) 201910105386.5

(51) Int. Cl. H02J 3/14; H02J 3/46

(52) U.S. Cl. CPC H02J 3/14; H02J 2003/003; H02J 3/46

(57) ABSTRACT

Provided are a method, master station and system for processing parameters of grid-load terminal. The method includes: receiving parameter information uploaded by at least one grid-load terminal, where the parameter information includes at least one of a user line parameter, a control parameter, a user configuration parameter, an acquisition parameter and a description parameter corresponding to the grid-load terminal; comparing the parameter information with user profile parameter information stored in the master station; and modifying inconsistent parameters in the user profile parameter information according to the parameter information if the parameter information is inconsistent with the user profile parameter information stored in the master station.

### CROSS-REFERENCE TO RELATED APPLICATIONS

This application claims priority to a Chinese patent application No. 201910105386.5 filed on Feb. 1, 2019, disclosure of which is incorporated herein by reference in its entirety.

### TECHNICAL FIELD

Embodiments of the present disclosure relate to the technical fields of stable control and load control of power systems, and particularly relate to a method, master station and system for processing parameters of a grid-load terminal.

### BACKGROUND

Voltage and current are introduced from a CT/PT secondary loop of a user line in collection of terminal load data. For lines with different voltage grades or different primary rated current, CT/PT variable ratio parameters are generally different. In order to accurately calculate and monitor primary power of an access line, multiple tuning parameters to be configurable need to be set. When the total power of interruptible loads is calculated, the lines need to be matched and selected. In order to control tripping exits in different load shedding modes, an exit function control soft platen and a trip rounds selection matrix shall also be configured. In addition, the terminal also has some configuration parameters and basic description information such as a terminal program version, image created time and communication configuration time. An existing parameter configuration method adopts manual operations, which is not only very inefficient, but also may cause unavoidable errors.

In construction and implementation of a user side terminal, generally, the terminal and debugging personnel on a master station side input parameters and build files one by one, or the debugging personnel on the master station by uploading configuration documents can input the parameters one by one and build files according to the documents. If a CPU board has a fault in a on-site terminal, the parameters need to be re-inputted after the board is replaced and are compared with those from the master station one by one. Once a database of the master station is abnormal or user information is lost, a lot of manpower is needed to be put into for reconfiguration, causing that the work is complicated and errors are still inevitable.

Problems of poor parameter consistency, error-prone collection of master station data, complicated defect processing and a mass of human input in the field implementation need to be solved urgently.

### SUMMARY

Embodiments of the present disclosure provide a method, master station and system for processing parameters of a grid-load terminal, so as to achieve complete matching of parameters of the terminal and a master station, comparison of changed parameters and automatic one-key file creating to overcome the problems of errors generated by configuring the parameters by manpower, putting into a great of manpower for debugging, low working efficiency, poor parameter consistency and no guarantee for accurate load shedding.

To solve the above technical problems, the present disclosure adopts the following technical solution.

In a first aspect, embodiments of the present disclosure provide a method for processing parameters of a grid-load terminal. The method is applied to a master station and includes: receiving parameter information uploaded by at least one grid-load terminal, where the parameter information includes at least one of a user line parameter, a control parameter, a user configuration parameter, a acquisition parameter and a description parameter corresponding to the grid-load terminal; comparing the parameter information with user profile parameter information stored in the master station; and modifying inconsistent parameters in the user profile parameter information according to the parameter information if the parameter information is inconsistent with the user profile parameter information stored in the master station.

In some embodiments, the method further includes: establishing a user profile for a user corresponding to the grid-load terminal according to the parameter information.

In some embodiments, a step of establishing a user profile for a user corresponding to the grid-load terminal specifically includes: creating a new user profile for the user according to the parameter information of the user if the user profile of the user is not stored in the master station; and issuing alarm information and difference prompt information if the user profile of the user is stored in the master station, to update the user profile of the user based on a profile creating instruction triggered manually.

In some embodiments, the method further includes: downloading the user profile parameter information to the grid-load terminal.

In a second aspect, embodiments of the present disclosure further provide a master station, including: an auto-collecting parameter module, an automatic comparison parameter module and an automatic profile creating parameter module.

The auto-collecting parameter module is configured to receive parameter information uploaded by at least one grid-load terminal, where the parameter information includes at least one of a user line parameter, a control parameter, a user configuration parameter, a acquisition parameter and a description parameter corresponding to the grid-load terminal.

The automatic comparison parameter module is configured to compare the parameter information with user profile parameter information stored in the automatic profile creating parameter module; and modify inconsistent parameters in the user profile parameter information according to the parameter information if the parameter information is inconsistent with the user profile parameter information stored in the automatic profile creating parameter module.

In some embodiments, the automatic profile creating parameter module is configured to establish a user profile for a user corresponding to the grid-load terminal according to the parameter information.

In some embodiments, the automatic profile creating parameter module is configured to create a new user profile for the user according to the parameter information of the user if the user profile of the user is not stored in the automatic profile creating parameter module; and issue alarm information and difference prompt information if the user profile of the user is stored in the automatic profile creating parameter module to update the user profile of the user based on a profile creating instruction triggered manually.

In some embodiments, the master station further includes: an automatic parameter downloading module. The automatic parameter downloading module is configured to download the user profile parameter information to the grid-load terminal.

In a third aspect, embodiments of the present disclosure further provide a system for processing parameters of a grid-load terminal, including: the master station having any feature in the second aspect, and at least one grid-load terminal.

In some embodiments, the grid-load terminal includes: a parameter uploading module and a parameter downloading and updating module.

The parameter uploading module is configured to upload the parameter information to the master station, where the parameter information includes at least one of a user line parameter, a control parameter, a user configuration parameter, a acquisition parameter and a description parameter corresponding to the grid-load terminal.

The parameter downloading and updating module is configured to download the user profile parameter information of the master station to change the parameters of the grid-load terminal.

The method for processing the parameters of the grid-load terminal provided by embodiments of the present disclosure includes: receiving the parameter information uploaded by at least one grid-load terminal, where the parameter information includes at least one of a user line parameter, a control parameter, a user configuration parameter, a acquisition parameter and a description parameter corresponding to the grid-load terminal; comparing the parameter information with user profile parameter information stored in the master station; and modifying inconsistent parameters in the user profile parameter information according to the parameter information if the parameter information is inconsistent with the user profile parameter information stored in the master station. All configurable parameters and description information of the grid-load terminal can be transmitted through a parameter transmission communication protocol between the master station and the grid-load terminal, so that the master station can view the current parameters of all grid-load terminals, and the comparison of the parameters of the grid-load terminals and of the master station is realized. The problems of errors generated by configuring the parameters by manpower, putting into a great of manpower for debugging, low working efficiency, poor parameter consistency and no guarantee for accurate load shedding, etc., are overcome, thereby solving actual problems in construction, transformation, system upgrade, and operation and maintenance of the source-grid-loads and providing guarantees for a source-grid-load master station system to accurately collect data of grid-load terminals, make correct control strategies and safely and stably control user load lines.

### BRIEF DESCRIPTION OF DRAWINGS

To more clearly describe the technical solution in embodiments of the present disclosure, the drawings to be used in description of the embodiments of the present disclosure will be simply presented below. Apparently, the drawings in the following description are merely some embodiments of the present disclosure. For those ordinary skilled in the art, other drawings can also be obtained according to the contents of embodiments of the present disclosure and these drawings without contributing creative labor.

FIG. 1 is a flow chart illustrating a method for processing parameters of a grid-load terminal provided by an embodiment of the present disclosure;

FIG. 2 is a schematic diagram illustrating a master station provided by an embodiment of the present disclosure; and

FIG. 3 is a schematic diagram illustrating a system for processing parameters of a grid-load terminal provided by an embodiment of the present disclosure.

### DETAILED DESCRIPTION

The present disclosure will be further described below in detail in combination with drawings and embodiments. It can be understood that specific embodiments described herein are only used for explaining the present disclosure, not used for limiting the present disclosure. In addition, it shall be indicated that for ease of description, drawings only show some structures related to the present disclosure rather than all structures.

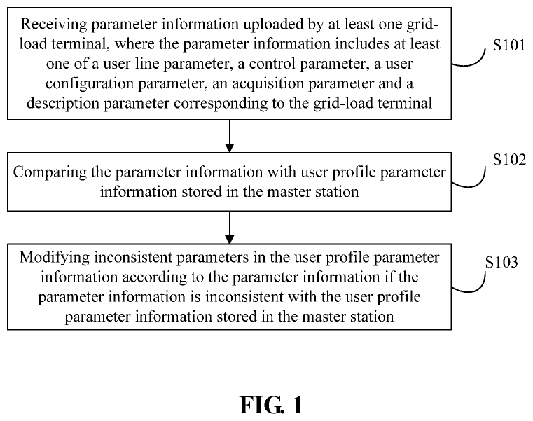

Embodiments of the present disclosure provide a method for processing parameters of a grid-load terminal. FIG. 1 is a flow chart illustrating a method for processing parameters of a grid-load terminal provided by an embodiment of the present disclosure. By referring to FIG. 1, the method is applied to a master station and includes the following steps.

In S101, Parameter information uploaded by at least one grid-load terminal is received. The parameter information includes at least one of a user line parameter, a control parameter, a user configuration parameter, an acquisition parameter and a description parameter corresponding to the grid-load terminal.

In the parameter information of a user corresponding to the grid-load terminal, the user line parameter includes: a line name, a voltage secondary rating, a current secondary rating, a PT variable ratio, a CT variable ratio, a wiring mode, a wattmeter method, a busbar group, a power direction and other related parameters. The line parameter includes: a accessing line name or field number marked by the user, a rating and a variable ratio setting for calculating a secondary power and a primary power, a primary wiring mode, a wattmeter method for calculating power, a name and number of a busbar group to which the line belongs, and a direction for calculating power. The line parameter can ensure the accurate expression of the line power and facilitate that the master station automatically creates the profile and collects the primary and secondary active power and the primary and secondary reactive power. The control parameter includes: a group total power selection matrix, an exit control soft platen and a tripping rounds selection matrix. The control parameter determines that the master station collects and calculates interruptible loads. The control parameter is a major parameter for performing the user load control. By obtaining the parameter configuration of the control parameter(s), the resectable user line and the current interruptable power can be accurately mastered under each of load control modes such as millisecond-level load shedding, second-level load shedding, minute-level load shedding, on-site closed-loop power control and electric charge power control. The user configuration parameter includes: a user name, a user number, a voltage grade, a capacity of power use, a user address, a subscription state, an asset number of a grid-load terminal, a network IP/Mask/Gateway, time of a grid-load terminal and other parameters related to field devices. Current basic information of various users can be definitely mastered by obtaining the user configuration parameter(s). The acquisition parameter refers to a coefficient for detecting remotely data channels via communication, including the parameters of an uploaded busbar voltage, a line current, a line active power, a line reactive power, a power factor, a frequency and a group total power, etc. By obtaining the coefficient of the acquisition parameter, it may be realized that the data is collected accurately and the data collected from the grid-load terminal are completely consistent with the data collected by the master station. Then, the collection defect of the grid-load terminal may be monitored remotely and accurately by the master station. The description parameter includes: inherent information such as a terminal program version, check code, image created time and a communication point table configuration time. The above information can be used to find whether the image of the grid-load terminal is updated and whether point table configuration is latest.

The grid-load terminal collects the parameter information of the corresponding user and uploads the parameter information to the master station. The parameter information may include at least one of the user line parameter, the control parameter, the user configuration parameter, the acquisition parameter and the description parameter corresponding to the grid-load terminal. The master station receives the parameter information uploaded by at least one grid-load terminal. The steps of the method realize collection of multiple parameters such as the user line parameter, the control parameter and the user parameter, etc. The collected parameters may accurately show the information and state of the current terminal, so as to master the user name, the user number, the voltage grade, the capacity of power use, the subscription state and the terminal asset number of a certain user in time, acquire the program version, the check code and image created time, and the communication point table configuration of the grid-load terminal, and discover errors on data point table configuration caused by version inconsistency in time, thereby providing a convenient means for finding the collection defect of the master station.

The parameters uploaded by the grid-load terminals are parsed to obtain various parameter information data uploaded by communication and verify the data uploaded by the grid-load terminal. When the data of the grid-load terminal does not pass the verification, an error alert is reported. In an exemplary embodiment, the reported error alert may include an information prompt such as parameter unable to be collected, and XX parameter error (i.e., a certain parameter being error), etc.

In S102, the parameter information is compared with user profile parameter information stored in the master station.

The user profile parameter information includes at least one of a user profile line parameter, a user profile control parameter, a user configuration parameter of the user profile, a user profile acquisition parameter and a user profile description parameter.

The at least one of the user line parameter, the control parameter, the user configuration parameter, the acquisition parameter and the description parameter corresponding to the grid-load terminal in the parameter information is compared with the corresponding user profile parameter information of the user stored in the master station. In an exemplary embodiment, the acquired user profile line parameter of the grid-load terminal is compared with the corresponding user profile line parameter of the user stored in the master station.

In S103, an inconsistent parameter in the user profile parameter information are modified according to the parameter information if the parameter information is inconsistent with the user profile parameter information stored in the master station.

If the parameter information is inconsistent with the user profile parameter information stored in the master station after comparison, the inconsistent parameter in the user profile parameter information is correspondingly modified according to the parameter information acquired from the grid-load terminal. Through comparison, parameter configuration problems of error on line parameter setting, inconsistent control parameters and change of the user parameters may be found, and especially, the major problem that the inconsistency of the control parameters has a direct impact on the user load control and further has an impact on operation safety of the source-grid-load system may be found, which has important practical significance. In the user parameter information, the parameter information such as the user name, the user number, the voltage grade and the capacity of power use, etc., which may change due to production suspension and cancellation of the user, reformation of capacity expansion and the migration of the plant, may cause errors in statistics, analysis, operation and maintenance if for example the master station does not update in time. Through comparison of partial parameters or all parameters, the inconsistent parameters in the user profile parameter information are modified in time according to the parameter information, which may provide support for user profile management, system operation and maintenance and data analysis and at the same time may find configuration errors in time, thereby keeping the configuration of the terminal and the master station consistent in time and solving the problems that the master station cannot view the terminal parameters and the profile creating parameters of the master station are complicated to verify.

The method for processing the parameters of the grid-load terminal provided by embodiments of the present disclosure includes: receiving the parameter information uploaded by at least one grid-load terminal, where the parameter information includes at least one of a user line parameter, a control parameter, a user configuration parameter, a acquisition parameter and a description parameter corresponding to the grid-load terminal; comparing the parameter information with user profile parameter information stored in the master station; and modifying inconsistent parameters in the user profile parameter information according to the parameter information if the parameter information is inconsistent with the user profile parameter information stored in the master station. All configurable parameters and description information of the grid-load terminal can be transmitted through a parameter transmission communication protocol between the master station and the grid-load terminal, so that the master station can view the current parameters of all grid-load terminals, and the comparison of the parameters of the grid-load terminals and of the master station is realized. The problems of errors generated by configuring the parameters by manpower, putting into a great of manpower for debugging, low working efficiency, poor parameter consistency and no guarantee for accurate load shedding, etc., are overcome, thereby solving actual problems in construction, transformation, system upgrade, and operation and maintenance of the source-grid-loads and providing guarantees for a source-grid-load master station system to accurately collect data of grid-load terminals, make correct control strategies and safely and stably control user load lines.

In an embodiment, the method for processing the parameters of the grid-load terminal further includes that: the user profile is created for the user corresponding to the grid-load terminal according to the parameter information.

The user profile is created for the user corresponding to the grid-load terminal rapidly and accurately, user configuration is automatically completed, and accurate collection of the user data is realized. Creating the user profile for the user corresponding to the grid-load terminal may include single user profile creating, multi-user profile creating or batch selection profile creating.

In an embodiment, the step of creating the user profile for the user corresponding to the grid-load terminal may include the following two scenarios.

Scenario I: if the user profile of the user is not stored in the master station, the user profile is newly created for the user according to the parameter information of the user; and

Scenario II: if the user profile of the user is stored in the master station, alarm information and difference prompt information are issued to update the user profile of the user based on a profile creating instruction triggered manually.

If the user profile of the user is not stored in the master station, e.g., for a user under field debugging, then a user profile is newly created for that user according to the parameter information of the user. In an exemplary embodiment, the master station may complete single user profile creating within one minute, thereby greatly increasing the efficiency of profile creating and maintenance of the master station. If the user profile of the user is stored in the master station, e.g., for an inventory user with a profile, when the master station is selected to automatically create a profile, then alarm information and difference prompt information are issued, i.e., an alarm prompt and difference prompt information are given, for indicating a difference between the profile of the terminal and the profile of the master station. An operation and maintenance person selects whether to create a profile after manual confirmation, which increases a friendly interactive function of human-machine operation. The technical solution of the present embodiment achieves automatic one-key profile creating, solves the troubles of transferring and checking the parameters during installation and debugging of the grid-load terminal, ensures parameter synchronization of the master station and the grid-load terminal, and solves the problem of inconsistency of the grid-load terminal parameters and the master station profile.

In an embodiment, the method further includes that: the user profile parameter information is downloaded to the grid-load terminal.

The profile parameters of the master station are downloaded to a user side. For an abnormal condition that the CPU board of the terminal has a fault or the board is damaged, etc., the user profile parameter information is downloaded to the grid-load terminal, thereby realizing the downloading of remote backup parameter information and reducing the trouble of retrieving the parameters which are lost on site. The problem of parameter inconsistency of the master station and terminal is also solved through remote downloading, which has practical significance for migrating the user or reconstructing the user. The auto-downloaded parameter information is encapsulated and is transmitted to the grid-load terminal by communication, and whether the grid-load terminal downloads successfully is determined according to a message replied by the grid-load terminal, thereby solving the problems of parameter loss of grid-load terminal and setting difficultly the parameters of the grid-load terminal in operation and maintenance and realizing automatic synchronization of the parameters of the grid-load terminal.

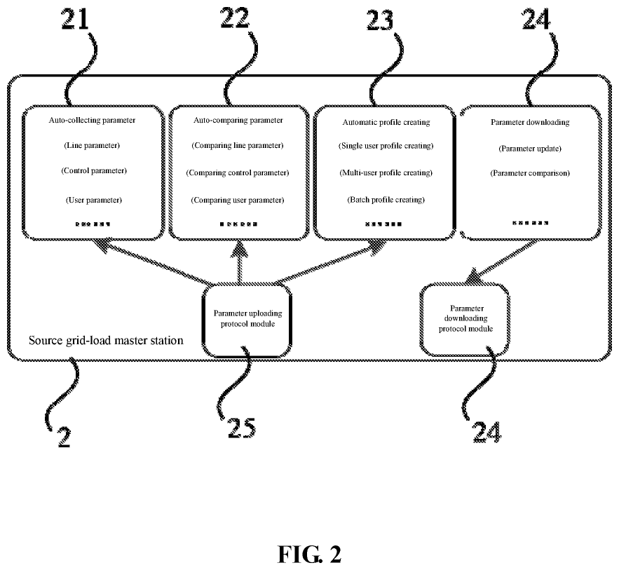

Embodiments of the present disclosure provide a master station. FIG. 2 is a schematic diagram illustrating a master station provided by an embodiment of the present disclosure. Referring to FIG. 2, the master station 2 includes: an auto-collecting parameter module 21, an automatic comparison parameter module 22 and an automatic profile creating parameter module 23.

The auto-collecting parameter module 21 is configured to receive parameter information uploaded by at least one grid-load terminal, wherein the parameter information includes at least one of a user line parameter, a control parameter, a user configuration parameter, an acquisition parameter and a description parameter corresponding to the grid-load terminal.

The automatic comparison parameter module 22 is configured to compare the parameter information with user profile parameter information stored in the automatic profile creating parameter module; and modify inconsistent parameters in the user profile parameter information according to the parameter information if the parameter information is inconsistent with the user profile parameter information stored in the automatic profile creating parameter module.

The user profile parameter information includes at least one of a user profile line parameter, a user profile control parameter, a user configuration parameter of the user profile, a user profile acquisition parameter and a user profile description parameter.

In an embodiment, the automatic profile creating parameter module 23 is configured to establish a user profile for a user corresponding to the grid-load terminal according to the parameter information.

In an embodiment, the automatic profile creating parameter module 23 is configured to create a user profile for the user according to the parameter information of the user if the user profile of the user is not stored in the automatic profile creating parameter module; and issue alarm information and difference prompt information if the user profile of the user is stored in the automatic profile creating parameter module, to update the user profile of the user based on a profile creating instruction triggered manually.

In an embodiment, the master station 2 further includes an automatic parameter downloading module 24, and the automatic parameter downloading module 24 is configured to download the user profile parameter information to the grid-load terminal.

In an embodiment, the master station 2 further includes an automatic parameter uploading protocol module 25. The automatic parameter uploading protocol module 25 is configured to parse the parameters uploaded by the grid-load terminal to obtain various parameter information data uploaded by the communication, check the data uploaded by the grid-load terminal, and give an error reminding when the data of the grid-load terminal does not pass the check.

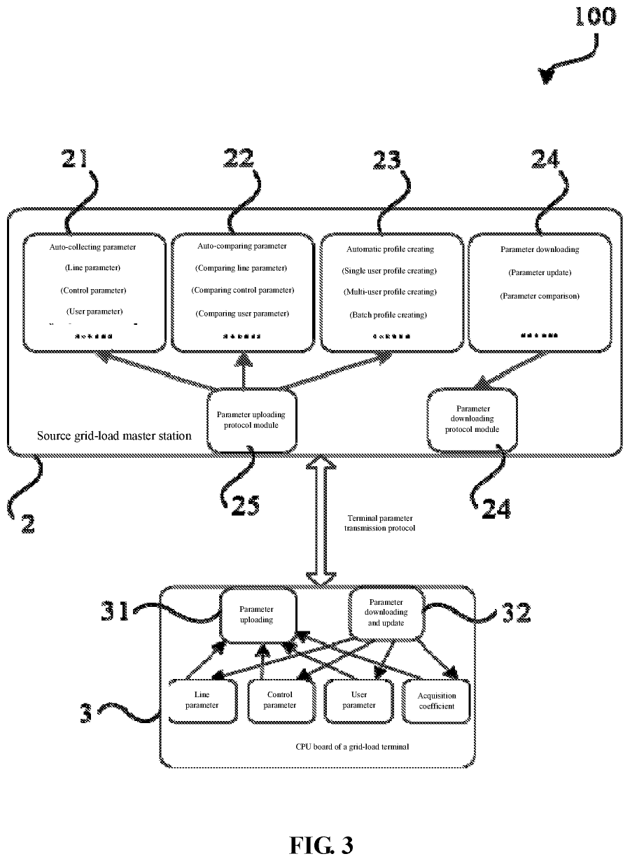

Embodiments of the present disclosure provide a system for processing grid-load terminal parameters. FIG. 3 is a schematic diagram illustrating a system for processing grid-load terminal parameters provided by an embodiment of the present disclosure. Referring to FIG. 3, the system includes: the master station 2 having any feature in the above embodiments, and at least one grid-load terminal 3.

Optionally, the grid-load terminal 3 includes: a parameter uploading module 31 and a parameter downloading and updating module 32.

The parameter uploading module 31 is configured to upload the parameter information to the master station, wherein the parameter information includes at least one of a user line parameter, a control parameter, a user configuration parameter, an acquisition parameter and a description parameter corresponding to the grid-load terminal.

The parameter downloading and updating module 32 is configured to download the user profile parameter information of the master station to change the parameters of the grid-load terminal.

The system for processing grid-load terminal parameters provided by the present embodiment includes the master station 2 having any feature in the above embodiments, and at least one grid-load terminal 3, fundamentally solves the problems of the collection defect of the master station data caused by a configuration error and switch mis-tripping of the user caused by a control setting error of the master station, and enhances safety and reliability of the source grid-load system.

Based on the above embodiment, the present embodiment further provides a computer readable storage medium which stores a computer program. An instruction in the storage medium, when executed by a processor of the system for processing grid-load terminal parameters, realizes the method for processing grid-load terminal parameters in any embodiment of the present disclosure. The method includes: parameter information uploaded by at least one grid-load terminal is received, wherein the parameter information includes at least one of a user line parameter, a control parameter, a user configuration parameter, a acquisition parameter and a description parameter corresponding to the grid-load terminal; the parameter information is compared with user profile parameter information stored in the master station; and inconsistent parameters in the user profile parameter information are modified according to the parameter information if the parameter information is inconsistent with the user profile parameter information stored in the master station.

Of course, the computer readable storage medium including an executable instruction provided by embodiments of the present disclosure can execute the instructions which are not limited to the above operation of method for processing grid-load terminal parameters, can also execute related operation in the method for processing grid-load terminal parameters provided by any embodiment of the present disclosure, and has corresponding functions and beneficial effects.

Through the above description for embodiments, those skilled in the art can clearly understand that the present disclosure can be achieved by means of software and necessary universal hardware, and of course, can also be achieved through hardware. However, in many cases, the former is a better embodiment. Based on such understanding, the technical solution of the present disclosure can be reflected in a form of a software product in essence or in a part of making a contribution to the existing art. The software product can be stored in a readable storage medium, such as a read-only memory (ROM), a random access memory (RAM), a flash and the like of the system for processing grid-load terminal parameters, including several instructions to enable one system device for processing grid-load terminal parameters to execute the method for processing grid-load terminal parameters in embodiments of the present disclosure.

It should be noted that, the above only describes preferred embodiments of the present disclosure and applied technical principles. Those skilled in the art shall understand that the present disclosure is not limited to specific embodiments described herein. For those skilled in the art, various apparent variations, readjustments and replacements can be made without departing from a protection scope of the present disclosure. Therefore, although the present disclosure is described in detail through the above embodiments, the present disclosure is not limited to the above embodiments and may further include more other equivalent without departing from the concept of the present disclosure, while the scope of the present disclosure is decided by a scope of attached claims.

What is claimed is:

1. A method for processing parameters of a grid-load terminal, applied to a master station and comprising:
receiving parameter information uploaded by at least one grid-load terminal, wherein the parameter information comprises at least one of a user line parameter, a control parameter, a user configuration parameter, an acquisition parameter and a description parameter corresponding to the grid-load terminal;
comparing the parameter information with user profile parameter information stored in the master station; and
modifying inconsistent parameters in the user profile parameter information according to the parameter information if the parameter information is inconsistent with the user profile parameter information stored in the master station.

2. The method according to claim 1, further comprising:
establishing a user profile for a user corresponding to the grid-load terminal according to the parameter information.

3. The method according to claim 2, wherein the step of establishing a user profile for a user corresponding to the grid-load terminal comprises:
creating a new user profile for the user according to the parameter information of the user if the user profile of the user is not stored in the master station; and
issuing alarm information and difference prompt information if the user profile of the user is stored in the master station, to update the user profile of the user based on a profile creating instruction triggered manually.

4. The method according to claim 1, further comprising:
downloading the user profile parameter information to the grid-load terminal.

5. A master station, comprising: an auto-collecting parameter module, an automatic comparison parameter module and an automatic profile creating parameter module, wherein
the auto-collecting parameter module is configured to receive parameter information uploaded by at least one grid-load terminal, wherein the parameter information comprises at least one of a user line parameter, a control parameter, a user configuration parameter, an acquisition parameter and a description parameter corresponding to the grid-load terminal; and
the automatic comparison parameter module is configured to compare the parameter information with user profile parameter information stored in the automatic profile creating parameter module; and modify inconsistent parameters in the user profile parameter information according to the parameter information if the parameter information is inconsistent with the user profile parameter information stored in the automatic profile creating parameter module.

6. The master station according to claim 5, wherein
the automatic profile creating parameter module is configured to establish a user profile for a user corresponding to the grid-load terminal according to the parameter information.

7. The master station according to claim 6, wherein
the automatic profile creating parameter module is configured to create a new user profile for the user according to the parameter information of the user if the user profile of the user is not stored in the automatic profile creating parameter module; and issue alarm information and difference prompt information if the user profile of the user is stored in the automatic profile creating parameter module, to update the user profile of the user based on a profile creating instruction triggered manually.

8. The master station according to claim 5, further comprising an automatic parameter downloading module;
wherein the automatic parameter downloading module is configured to download the user profile parameter information to the grid-load terminal.

9. A system for processing parameters of a grid-load terminal, comprising: the master station according to claim 5, and at least one grid-load terminal.

10. The system according to claim 9, wherein the grid-load terminal comprises: a parameter uploading module and a parameter downloading and updating module;
the parameter uploading module is configured to upload the parameter information to the master station, wherein the parameter information comprises at least one of a user line parameter, a control parameter, a user configuration parameter, an acquisition parameter and a description parameter corresponding to the grid-load terminal; and
the parameter downloading and updating module is configured to download the user profile parameter information of the master station to change the parameters of the grid-load terminal.
